(19) United States
(12) Patent Application Publication
(10) Pub. No.: US 2022/0081253 A1
(43) Pub. Date: Mar. 17, 2022

(54) METHOD AND BRAKE CONTROLLER FOR CONTROLLING A BRAKE IN AN ELEVATOR SYSTEM

(71) Applicant: Inventio AG, Hergiswil (CH)

(72) Inventor: Urs Lindegger, Ebikon (CH)

(21) Appl. No.: 17/309,787

(22) PCT Filed: Dec. 18, 2019
(86) PCT No.: PCT/EP2019/086002

§ 371 Date: Jun. 18, 2021

(30) Foreign Application Priority Data
Dec. 20, 2018 (EP) 18214651.4

(51) Int. Cl. B66B 1/32; B66B 5/02

(52) U.S. Cl. CPC B66B 1/32; B66B 5/02

(57) ABSTRACT

A brake of an elevator system is controlled by a brake controller, the brake having an armature that is pulled by an electromagnet to release the brake from a braking position against a spring force into a release position, according to a method including the steps of: applying an initial electrical voltage to the electromagnet and measuring a current intensity then supplied to the electromagnet; and reducing the voltage applied to the electromagnet to a holding voltage in response to a detection of a typical time behavior of the measured current intensity, which detected behavior characteristically occurs when the armature moves from the braking position into the release position. The method allows the brake to be activated more quickly from a released state to a braking state in specific situations.

### FIELD

The present invention relates to a method for controlling a brake of an elevator system. The invention also relates to a brake controller which is set up to carry out the proposed method, as well as an elevator system equipped therewith.

### BACKGROUND

When operating an elevator system, a high level of safety must be ensured, in particular to be able to avoid hazards for passengers. For this purpose, among other things, a brake is usually provided in the elevator system, with the aid of which a displacement movement of displaceable components such as in particular an elevator car and/or a counterweight can be braked or stopped and/or held in position.

Various types of brakes for elevator systems are known. For example, a brake can be arranged directly on the component to be braked, i.e. on the elevator car and/or the counterweight, and thus move along with it. To brake the moving component, the brake can then interact with a stationary component within the elevator system. For example, the brake can press brake pads against a stationary rail in order to slow down the movement of the component to be braked due to the resulting friction.

Alternatively, a brake can interact, for example, with a drive machine, with the aid of which a component to be moved can be displaced. For example, the drive machine can drive rope-like or belt-like suspension elements which are connected to the elevator car and/or the counterweight. For this purpose, the drive machine can, for example, have a drive pulley over which the suspension elements run and can be driven by traction. In this case, the brake can interact with the drive pulley or a component mechanically coupled to the drive pulley in order to brake the latter and thus indirectly slow down a movement of the component to be braked.

For example, U.S. Pat. No. 7,909,145 B2 describes a braking device for an elevator with a monitoring function.

The brake of an elevator system is typically designed in this way in order to be able to fulfill the high safety requirements to be met in an elevator system and, in particular, to also ensure that, for example, the elevator car is reliably stopped and/or held in position even in the event of a system failure or a failure of a power supply that it must be actively opened so that it is automatically activated, i.e. closed, in the event of a power failure, for example. In a configuration that is frequently used, the brake has a so-called armature for this purpose, which is actuated by an electromagnet. In order to release the brake, the armature can be pulled by the electromagnet from a first configuration, which is referred to herein as the braking position, against a spring force into a second configuration, which is referred to herein as the release position. In the event of a power failure, a component causing the spring force, such as a return spring, ensures that the brake is automatically displaced into its braking position.

Brakes cannot only be used in elevator systems to prevent the counterweight or the elevator car from falling (depending on the load of the car) in emergency situations such as a malfunction and/or failure of the drive. In addition, brakes in elevator systems can also be used, among other things, to avoid displacing the elevator car at excessively high speeds (“overspeed protection”) and/or unintended elevator car movement (“unintended car movement protection”).

For example, it is conceivable that malfunctions occur during the operation of an elevator system, which lead to the elevator car being moved upward or downward faster than a permissible maximum speed. An upward movement can be caused by the counterweight coupled to the elevator car, which as a rule has a higher mass than the empty elevator car. A displacement movement that is too fast can lead to potentially dangerous situations.

Furthermore, when operating elevator systems, the intention is generally not to move the elevator car as long as an elevator door, i.e. an elevator car door and/or an elevator shaft door, is not completely closed. This is intended, among other things, to prevent passengers from getting through the partially open elevator door into a dangerous region between the elevator car and elevator shaft and possibly being trapped there when the elevator car is moving.

However, there may be exceptions to this rule. For example, in the context of level adjustment (“relevelling”) it may be desired to keep an elevator car always positioned when it stops at a floor in such a way that its floor is flush with a floor. When passengers get into or out of the elevator car, a slight displacement of the elevator car can take place due to the load change that is brought about and an associated change in length of the suspension elements holding the elevator car. In order to be able to compensate for such slight displacements of a few centimeters without any problems, a movement of the elevator car can be permissible despite the elevator car door being open, as long as the elevator car is still located within a tolerance range above or below an intended stopping position.

As a further exception to the above rule, it can be provided that shortly before an elevator car reaches an intended stopping position, an elevator door may begin to be opened. As a result, an opening process and thus boarding and exiting of passengers while the elevator car has been brought to a stop at the stopping position can be accelerated. In this case, too, early opening and/or, in an analogous manner, delayed closing of the elevator door and thus relocation of the elevator car with the elevator door not completely closed should only be permitted as long as the elevator car is located within a tolerance range above or below an intended stopping position.

In the case of the two last-mentioned arrangements in particular, it may be necessary to be able to reliably detect whether a displacement movement of the elevator car with the elevator door not fully closed is to be assessed as an unintentional movement or whether it falls under one of the two aforementioned exceptions, for example.

A very simple approach for this is to check whether the elevator car is located within the tolerance range above or below the intended stopping position. If this is not the case, the elevator system's brake can be activated automatically, for example. For example, this can be done by interrupting a safety chain of the elevator system, as a result of which a power supply to the brake is automatically interrupted and the brake is then activated.

However, such an approach can lead to the elevator car already moving at a relatively high speed when it leaves the tolerance range above or below the intended stopping position. In order to avoid that the elevator car is then displaced excessively far away from the stopping position and potentially dangerous situations arise as a result, such as a free space between the elevator car and an elevator shaft opening through which, in the worst case, a person could fall into the elevator shaft when the elevator shaft door is open, it is aimed to be able to stop the elevator car as quickly as possible in such a case.

It was recognized that stopping the displacement movement of an elevator car in conventional elevator systems cannot be carried out sufficiently quickly in all cases.

### SUMMARY

Among other things, there may be a need for a method for controlling a brake of an elevator system, with the aid of which a displacement movement of an elevator car can be stopped quickly and reliably. Furthermore, there may be a need for a suitably configured brake controller and an elevator system equipped with it.

Such a need can be met with a subject matter according to the advantageous embodiments defined and specified in the description below.

According to a first aspect of the invention, a method for controlling a brake of an elevator system is proposed. The brake has an armature which is to be pulled by an electromagnet to release the brake from a braking position against a spring force into a release position. The method comprises at least the following steps, preferably in the order given:

applying an initial electrical voltage to the electromagnet and measuring a current then supplied to the electromagnet; and
reducing the voltage applied to the electromagnet to a holding voltage in response to detection of a typical time behavior of the measured current, which characteristically occurs when the armature moves from the braking position into the release position.

According to a second aspect of the invention, a brake controller for controlling a brake of an elevator system is proposed, the brake having an armature which is to be pulled by an electromagnet for releasing the brake from a braking position against a spring force into a release position, the brake controller being configured to control a method in accordance with one embodiment of the first aspect of the invention.

According to a third aspect of the invention, an elevator system is proposed comprising a brake that has an armature, which is to be pulled by an electromagnet to release the brake from a braking position against a spring force into a release position, and a brake controller in accordance with one embodiment of the second aspect of the invention.

Possible features and advantages of embodiments of the invention can be considered, among others, and without limiting the invention, to be based on the ideas and findings described below.

As briefly stated in the introduction, it can be important for the safe operation of an elevator system to be able to brake the moving elevator car quickly and efficiently with the aid of a brake.

A braking process caused by a brake is generally influenced by a plurality of factors. Among other things, it is important on the one hand how quickly the previously released brake can be activated when the need for braking is detected. On the other hand, it has an impact on how efficiently the activated brake can then brake the elevator car. Both factors influence how quickly the elevator car can be stopped after recognizing the need for braking.

How quickly a brake can be activated depends, among other things, on the structural and functional properties of the brake itself. For brakes of elevator systems, a design is generally used in which an armature can be displaced between a braking position and a release position with the aid of an electromagnet, i.e. with the aid of a coil into which the armature can, for example, dip. As long as the electromagnet is not activated, i.e. energized, it does not exert any force on the armature. In this configuration, the armature is pressed into the braking position, for example by a spring element with a spring force. In this braking position, the armature presses, for example, brake pads against a component that moves relative to the brake, such as, for example, a drive disk that is rotatable between the brake pads or a brake rail that can be displaced relative to the brake pads. Thus, when the brake is in its braking position, the elevator car is braked in its displacement movement or held in a stop position. To release the brake, the armature can be pulled into the release position with the aid of the electromagnet. In this release position, the brake pads operated by the armature are pulled away from the component moving relative to the brake, so that no braking effect is generated.

With such a brake, the activation of the brake basically comprises two steps. First of all, any force exerted by the electromagnet on the armature must be largely canceled out. For this purpose, the electrical current flowing through the coil of the electromagnet must be sufficiently reduced until the force generated by the electromagnet is at least less than the spring force acting on the armature in the opposite direction. The spring force then has to be strong enough to be able to use the armature to press the brake pads with a suitable force against the components moving relative to the brake.

The approach presented here mainly addresses that aspect of the braking process to be effected by the brake in which, when a need for braking is detected, the force generated by the electromagnet on the armature is to be reduced quickly and efficiently.

In general, the force with which the electromagnet pulls the armature toward the release position depends on the intensity of a magnetic field produced by the electromagnet and thus on an electrical current density produced in the coil of the electromagnet. In order to be able to release the brake quickly and efficiently, a high initial electrical voltage is usually applied to the coil of the electromagnet at the beginning of a release process. It also comes into play here that the brake is often structurally designed in such a way that, as long as the brake is in the braking position, there is a larger air gap between the armature and the electromagnet, which is then reduced when the armature is pulled into the release position. This initial air gap reduces the force initially exerted on the armature by the electromagnet during a release process. However, since this force must be greater than the spring force acting on the armature in order to be able to pull the armature into the release position, a higher current intensity is required in the coil of the electromagnet at the beginning of the release process and a higher initial voltage is accordingly applied.

As soon as the armature has been pulled into the release position, the air gap between the armature and the electromagnet is smaller, so that there is a greater force acting on the armature. This can then be used to reduce the current intensity flowing through the coil of the electromagnet again. With such a reduced current intensity, however, sufficient force can still be exerted on the armature to hold it in the stopping position. By reducing the current intensity, it is possible, inter alia, to avoid excessive heat development in the electromagnet.

In other words, at the beginning of a release process, what is known as overexcitation of the coil of the electromagnet can be brought about by applying a high initial electrical voltage. When the armature has then been pulled into the release position, this electrical voltage can be reduced to a holding voltage.

There have been various technical approaches to date for the manner in which and/or when the electrical voltage applied to the coil of the electromagnet is reduced from the high initial voltage to the lower holding voltage. In a simple approach, the voltage is reduced to the holding voltage after a specified time interval, for example after one second. In a more complex approach, it is for example possible to determine by means of sensors or switches whether the armature or the brake pads coupled to it are in the braking position or in the release position. During a release process, the voltage applied to the coil of the electromagnet can be reduced as soon as it has been recognized by the sensors or switches that the armature has been pulled into the release position.

However, additional hardware in the form of sensors or switches is necessary for the last-mentioned approach, which can increase the costs and/or complexity of the brake. In addition, as relatively complex components, the sensors or switches can be subject to wear and/or to a risk of defects.

In comparison to this, the first-mentioned approach can be implemented in a technically simpler manner. However, with this approach, the applied voltage is reduced to the holding voltage regardless of whether or when the armature was moved into the release position. The applied voltage can thus be reduced unnecessarily late or, in the opposite, worse case, the applied voltage can be reduced to the holding voltage before the armature has been pulled into the release position, so that the armature may not come loose.

The approach presented here aims to reduce the voltage applied to the electromagnet to the holding voltage as early as possible without risking that the armature is not pulled into the release position by reducing the applied voltage too early. However, complex components such as switches or sensors should preferably be dispensed with.

Instead, it is suggested to measure the electrical current intensity that is generated in the coil of the electromagnet when the initial electrical voltage is applied to it, in order to be able to derive information about the behavior of the armature from this.

It was recognized that the time course of this measured current intensity changes in a characteristic manner when the armature moves from the braking position into the release position. In other words, by measuring the electrical current intensity that is established in the electromagnet during a release process on the basis of the characteristic time current intensity patterns that occur, it can be recognized when the armature of the brake moves into the release position. This can then act as a trigger to reduce the high initial voltage on the electromagnet to the holding voltage. The applied voltage can thus be reduced as soon as the armature has reached the release position and the high initial voltage is no longer required, but the lower holding voltage is sufficient to hold the armature in the release position.

This early reduction of the applied voltage can now contribute in the following way to accelerating the activation of the brake when the need for braking is recognized.

While the brake is released, an electric current must flow through the coil of the electromagnet in order to pull the armature of the brake in the direction of the release position with the magnetic field generated thereby and thus to keep it in the release position. In order to then activate the brake, this electrical current and thus the generated magnetic field must be significantly reduced in order to release the armature from the release position so that it is displaced into the braking position due to the opposing spring force.

However, the coil of the electromagnet has an inductance, i.e. energy is stored in the magnetic field it generates. To reduce the generated magnetic field, this energy must be dissipated, i.e. consumed or converted.

If an electrical current flow through an inductance is to be reduced or switched off, the current flowing in the inductance must be diverted into an additional current path, for example, since otherwise high induced voltages could cause damage. For this purpose, for example, a diode connected in parallel to the inductance and optionally a separate electrical resistor can be used. The energy stored in the coil of the electromagnet can thus be dissipated as soon as the applied voltage is reduced or switched off, in that when a current flows through the circuit created by the parallel diode, losses occur due to the electrical resistance within the coil itself and possibly additional losses occur due to the separate electrical resistor.

How long it takes until the energy stored in the electromagnet is reduced to such an extent that the force produced by the electromagnet is no longer sufficient to hold the armature in the release position and the armature thus moves into the braking position depends largely on the amount of energy stored in the electromagnet.

The energy W stored in a coil is proportional to the square of the current intensity I flowing through the coil and to the inductance L of the coil. In general, W=(I²*L)/2 applies. If the coil for releasing the brake is connected to a constant voltage U, the current intensity I flowing through the coil is only limited by the electrical resistance R of the coil. I=U/R applies. The stored energy W thus results in W=(U²*L)/(2*R²). In other words, the energy W stored in the coil depends on the square of the voltage U applied to the coil.

The higher the voltage applied to the coil of the electromagnet, the more energy has to be dissipated before the electromagnet can release the armature again and move it into its braking position. If, for example, twice as high a voltage (2*U1) is applied to the coil of the electromagnet, a four times higher energy must be dissipated when the electromagnet is subsequently switched off than in the case in which only a single voltage U1 is applied.

The lower the voltage applied to the electromagnet is selected for releasing the armature into the release position during a release process or the earlier an initially higher initial electrical voltage is reduced to a lower holding voltage, the shorter the duration that is required can be kept to reduce the energy already stored in the electromagnet and thus to bring the brake with its armature back into its braking position, i.e. to activate the brake.

In the method presented here for controlling a brake, the point in time at which the initially higher electrical voltage applied to the electromagnet of the brake is reduced to the lower holding voltage can be selected optimally early.

For this purpose, on the basis of a typical time behavior of the measured current intensity guided in the electromagnet, it can be recognized when the armature has moved into the release position in order to then be able to reduce the applied voltage to the holding voltage at a very early point in time.

Thus, even in an arrangement in which the brake should first be released and thus an electrical voltage was applied to its electromagnet, a quick reactivation of the brake can be effected, since the energy stored in the coil and then to be dissipated substantially relies on that energy can be limited, which is required to keep the armature in the release position thereof.

In contrast to this, a high initial voltage was conventionally applied to the coil of the electromagnet for much longer, so that a higher energy was stored in the coil before it was then reduced to the holding voltage at a later point in time. Thus, with conventional approaches, a stronger magnetic field was generated for a time than was necessary to hold the armature and thus a higher energy was stored in the coil, which, in the event that the brake should be activated precisely during this period, would lead to that the time required to dissipate this increased energy is relatively long, so that there is a delayed activation of the brake.

In comparison to this conventional approach, the method presented here can thus be used to accelerate an activation of the brake, at least in certain arrangements, during a previously initiated release process.

In the following, examples will be used to explain how, based on the time behavior of the measured current intensity by the electromagnet, it can be recognized when the armature has moved from the braking position into the release position.

The behavior over time of the current intensity I(t) measured at the electromagnet when an electrical voltage is applied to it can be influenced by different influences. In principle, this current intensity increases continuously over time t and depending on the inductance L up to a saturation value I0. The general rule is:

I(t)=I0*(1−exp((t*R)/L)

However, the inductance of the coil of the electromagnet is not necessarily constant even during a brake release process. Instead, this inductance generally depends on the position of the armature, particularly if it is made entirely or partially of ferromagnetic material. When the armature is in the braking position, it is usually located relatively far away from the coil, so that its inductance while the brake is closed is relatively low. As soon as the armature moves into the release position, it comes closer to the coil or dips further into it, so that its inductance increases when the brake is released.

During a release process, in which the armature is initially moved from the braking position into the release position, the inductance of the coil of the electromagnet changes over time. This change in inductance leads to a behavior of the current intensity flowing through its coil, which is typical for the electromagnet used in the brake, when the armature moves from the braking position into the release position.

According to one embodiment of the invention, a reduction in the measured current intensity can be recognized, for example, as a typical time behavior, when the initial voltage is applied.

In other words, to open the brake, the initial voltage can be applied to its electromagnet. An electric current then begins to flow through the coil of the electromagnet. The current intensity increases over time until the current generates a magnetic field that is strong enough to move the armature from its braking position to its release position. However, this also changes the inductance of the coil itself, so that the electrical current flowing through it briefly decreases before it then increases again. This brief reduction in the current intensity measured at the electromagnet can thus be used as an indication that the armature has moved from the braking position into the release position. When this brief reduction in the current intensity is recognized, the applied voltage can thus be reduced to the holding voltage. A reversal point in the course of the current intensity over time, i.e. the point from which the current intensity decreases at least for a short time, can technically be relatively easily recognized. The currently prevailing current intensity can then be stabilized or the holding voltage can be applied.

Alternatively, according to one embodiment of the invention, a renewed increase after a previous decrease in the measured current with an applied initial voltage can be recognized as a typical time behavior.

In other words, it is not the brief drop in the measured current but rather the subsequent increase in the current through the coil of the electromagnet that can be used as an indication of when the armature has moved from the braking position into the release position. At this point in time, the current intensity flowing through the coil is less than when the current began to drop. Such a renewed increase in the current can also be easily recognized technically. The current intensity prevailing here can then be stabilized or the holding voltage can be applied.

As a further possibility, according to one embodiment of the invention, a typical time course of a current intensity with an applied initial voltage can be determined in advance by a method selected from a group comprising calculation, simulation, and modeling. As a typical time behavior, a match can then be recognized within a predetermined tolerance between the measured current, when applying the initial voltage, and the determined typical time course of the current intensity.

In other words, a time course with which the current intensity flowing through the coil of the electromagnet changes when the high initial voltage is applied can be calculated, simulated, or modeled. It can be taken into account that the inductance of the coil changes in the course of the release process when the armature is displaced from the braking position into the release position. The time behavior of the current intensity calculated, simulated, or modeled as a result can be used as a reference. The current intensity actually measured at the electromagnet can be compared with this reference behavior. If a match between the two time behaviors can be observed within a predeterminable tolerance, conclusions can be drawn from this about the movement of the armature from the braking position to the stopping position. This in turn can serve as a trigger to reduce the applied voltage to the holding voltage or to stabilize the current intensity at a low level. If a deviation outside of the predeterminable tolerance of both time behaviors can be observed, this can be used to infer a faulty state of the brake. This in turn can serve as a trigger for outputting an error signal, which can be used to inform a service technician about the necessity of a service call or, in the event of a significant deviation, to stop the elevator system entirely by outputting an error signal. Such a deviation can arise in particular with the nominal current. This can occur, for example, when there is a winding short circuit or the windings are overheated, which leads to a braking current that is higher than the intended nominal current. Such a deviation can also be caused by mechanical jamming of the brake.

According to one embodiment of the invention, the holding voltage can be greater than or equal to an electrical voltage that is to be applied to the electromagnet in order to hold the armature in the release position.

In other words, the holding voltage can be selected such that it is sufficient to hold the armature in its release position by the electromagnet when the latter has previously reached the release position. The holding voltage does not need to be selected so high that it would be sufficient to move the armature from the braking position into the release position. However, the higher initial voltage applied at the beginning of the release process should be able to do this.

According to one embodiment of the invention, the holding voltage can be lower than the initial voltage by 10% to 90%, preferably at least 80%, at least 70% or at least 60%, particularly preferably at least 50% or at least 40% or at least 30% or at least 20%.

With such a holding voltage that is considerably lower in comparison to the initial voltage, the energy stored in the coil of the electromagnet can, as described above, be limited to a lower level. Accordingly, if the brake is suddenly to be activated again, this energy can be quickly dissipated and the armature can thus be moved back into the braking position, driven by the spring force.

According to one embodiment of the invention, a brake release confirmation signal can be output when the typical time behavior of the measured current intensity is recognized.

In other words, when the typical time behavior of the current intensity is recognized, which occurs when the armature is pulled from the braking position into the release position during a release process, not only the initial voltage applied to the electromagnet can be reduced to the holding voltage, but a brake release confirmation signal can also be output. This brake release confirmation signal can, for example, be forwarded to other components of the elevator system and analyzed there. Due to this signal, it can be confirmed that the brake has been released, i.e. that the armature of the brake has actually been moved from the braking position into the release position.

By monitoring the brake release confirmation signal, it can thus be recognized that not only has a release process been initiated by applying a voltage to the electromagnet of the brake, but that an actual displacement of the armature and a release of the brake has taken place. The output brake release confirmation signal can act in a similar way to a signal from sensors or switches as used in conventional brakes to monitor the current state of the brake with regard to the current position of its armature. However, this does not require any additional sensors or switches, but only a measurement of a current intensity and an analysis of its behavior over time.

Embodiments of the method presented herein for controlling a brake of an elevator system can be implemented, controlled, or monitored in an embodiment of a brake controller according to the second aspect of the invention. For this purpose, the brake controller can have a current measuring device with the aid of which the current intensity flowing in the electromagnet of the brake can be measured. The brake controller can also have a suitable analysis device with the aid of which the measured current intensity can be analyzed. In particular, the analysis device can be configured to recognize time behavior patterns in the measured current intensity that characteristically occur when the armature of the brake moves from the braking position into the release position. For this purpose, the analysis device can, for example, recognize reversal points, gradients, local extremes, or the like in a time course of the current intensity. Alternatively, a previously calculated, simulated, or modeled typical time behavior of the current intensity can be stored in the analysis device and a then actually measured time behavior of the current intensity can be compared with this reference in order to be able to identify matches.

A brake controller designed in this way can be used in an elevator system to control a voltage supply to the electromagnet of the brake. The voltage supply can be designed to switch between an initial high voltage and a lower holding voltage, controlled by the brake controller. Alternatively, the voltage supply can provide the initial high voltage and the lower holding voltage at separate outputs, and the brake controller can control a switching device with the aid of which one of these voltages is passed on to the electromagnet of the brake.

It should be noted that some of the possible features and advantages of the invention are described herein with reference to different embodiments of the method according to the invention for controlling a brake of an elevator system on the one hand and the brake controller configured for the implementation of the method on the other. A person skilled in the art recognizes that the features can be combined, adapted, or replaced as appropriate in order to arrive at further embodiments of the invention.

In the following, embodiments of the invention shall be described with reference to the attached drawings, wherein neither the drawings nor the description are intended to delimit the invention.

### DESCRIPTION OF THE DRAWINGS

FIG. 1 shows a brake of an elevator system in accordance with one embodiment of the present invention.

FIG. 2 illustrates a current intensity as it occurs as a function of time in an electromagnet of a brake of an elevator system in accordance with one embodiment of the present invention.

FIG. 3 illustrates a circuit diagram of a brake controller for controlling a brake of an elevator system in accordance with one embodiment of the present invention.

The drawings are merely schematic and not true to scale. Like reference signs refer to like or equivalent features in the various drawings.

### DETAILED DESCRIPTION

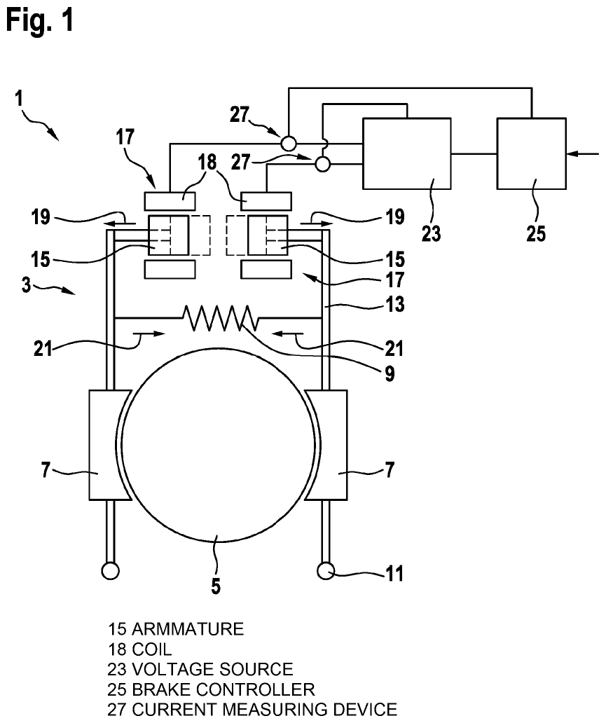

FIG. 1 illustrates a brake 3 of an elevator system 1 in accordance with one embodiment of the invention. The elevator system 1 can have displaceable components such as an elevator car and/or a counterweight, which can be held and displaced, for example, via belt-like suspension elements (not illustrated in the drawing for reasons of clarity). The suspension elements can be displaced by means of a traction disk 5.

In order to be able to brake a displacement movement of the elevator car and/or the counterweight, the brake 3 can be pressed with brake pads 7 against a circumferential surface of the traction disk 5, for example. For this purpose, the brake pads can be attached to levers 13 which, for example, can each be pivoted about a bearing 11. A pressing force can be generated, for example, by a spring element 9. For reasons of symmetrical force generation, two brake pads 7 with associated levers 13 on both sides of the traction disk 5 are shown in the example shown.

The levers 13 of the brake 3 each have an armature 15 at the opposite ends of the bearings 11. The armature 15 can be moved with an electromagnet 17 in a direction 19 opposite to the direction 21 of the spring force caused by the spring element 9. For this purpose, a voltage can be applied to the electromagnet 17 from a voltage source 23 in order to generate a magnetic field in the electromagnet 17 by means of the electric current caused thereby, with which the armature 15 can be attracted. The armature 15 can thereby be pulled into the release position shown in FIG. 1 against the spring force caused by the spring element 9 (the braking position of the armature 15 is shown in dashed lines in FIG. 1). As a result, the levers 13 and the brake pads 7 are moved laterally away from the traction disk 5, and the brake 3 is thus released.

In order to pull the armature 15 out of the braking position into its release position, a relatively high initial electrical voltage is first applied to the respective electromagnet 17 with the aid of the voltage source 23. The initial voltage must be high, among other things, because the armature 15 in the braking position partially protrudes from the coil 18 of the electromagnet 17, so that the magnetic field generated by the coil 18 exerts a less strong force on the armature 15 than would be the case in the state submerged into the coil 18.

Only after the armature 15 has been at least partially pulled further into the coil 18 and thus has reached its release position or at least comes close to it, the initial voltage can be reduced to a holding voltage. In a practical example, the initial voltage can be about twice the holding voltage. For example, the initial voltage can be around 200V, while the holding voltage can be around 100V.

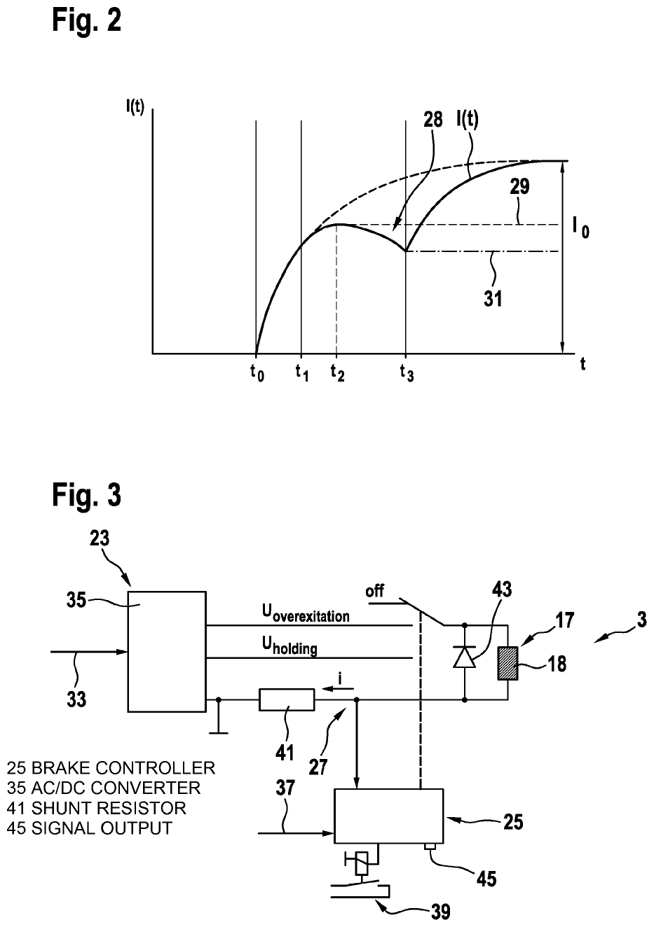

FIG. 2 shows a typical time course of a current intensity I(t) through the coil 18, as it occurs when an electrical voltage is applied to the electromagnet 17 at the point in time to in order to move the armature 15 from the braking position into the release position.

A typical course of the current intensity I(t), as it would occur if the inductance of the coil 18 were constant in this case, is shown in dashed lines.

However, the inductance of the coil 18 is actually not constant during a release process in order to release the brake 3. Instead, this inductance changes when the armature 15 moves from the braking position into the release position and, in the process, dips deeper into the coil 18. Accordingly, the behavior of the current that is actually established in the coil 18 during the release process has a type of “dent” 28.

From a point in time t₁, from which the armature 15 begins to move toward the coil 18, the inductance of the coil 18 increases, so that the current intensity I(t) actually flowing through the coil 18 is lower than in the case in which the inductance is constant. From a point in time t₂, the current intensity I(t) even decreases temporarily. At a point in time t3, the armature 15 then reaches its release position and the inductance of the coil 18 reaches its maximum value. From then on, the current intensity I(t) increases again until it reaches its saturation value I₀.

In order to activate the brake 3, the current flowing in the electromagnet 17 must be reduced or switched off. The armature 15 is then displaced, driven by the spring force of the spring element 9, toward the braking position (shown in dashed lines in FIG. 1), whereby the levers 13 and brake pads 7 are moved toward the traction disk 5 and brake the rotational movement thereof by friction.

When reducing the current flowing through the electromagnet 17, however, the energy stored in the coil 18 must be dissipated. The higher the current intensity I(t) carried in the coil 18, the greater the amount of this energy.

The initial voltage applied to the electromagnet 17 at the beginning of a release process is significantly greater than the release voltage that is required to hold the armature 15 in the release position, which armature has already been displaced into its release position. In order to keep the current intensity I(t) conducted in the coil 18 as low as possible, the aim is therefore to reduce the initial voltage to the holding voltage as early as possible during the release process. However, this must not happen at a point in time well before the armature 15 has reached the release position, since otherwise there is a risk that the armature 15 is no longer pulled into the release position or is held there. In particular, this must not happen before the above-mentioned point in time t₁ and should preferably only happen from the above-mentioned point in time t₂.

It is therefore proposed to reduce the voltage applied to the electromagnet 17 to the holding voltage only when it can be recognized based on an observation of the current intensity I(t) flowing in the electromagnet 17 that the armature 15 is moving from the braking position into the release position.

For this purpose, a brake controller 25 can, for example with current measuring devices 27, measure the current intensity I(t) currently flowing through the coil 18 of the electromagnet 17 and, due to the characteristic curves observed, indirectly infer the movement of the armature 15 and then trigger the voltage source 23 in a suitable manner to reduce the applied voltage to the holding voltage.

For example, the brake controller 25 can recognize when the measured current intensity I(t) begins to decrease when the initial voltage is applied at the above-mentioned point in time t₂. The current intensity can then be stabilized at this point in time, as is shown in FIG. 2 with the dashed line 29, or the voltage applied to the electromagnet 17 can be reduced to the holding voltage.

Alternatively, the brake controller 25 can detect when the measured current intensity I(t) begins to rise again at the above-mentioned point in time t3 with the initial voltage applied. The current intensity can then be stabilized at this point in time, as is shown in FIG. 2 with the dash-dotted line 31, or the voltage applied to the electromagnet 17 can be reduced to the holding voltage.

FIG. 3 shows a schematic representation of a circuit in which the behavior of a brake 3 can be controlled with the aid of a brake controller 25.

An AC/DC converter 35 acting as a voltage source 23 is supplied by a power supply 33. The voltage source 23 can generate an initial high voltage U_{overexcitation} and a lower holding voltage U_{holding}.

At the beginning of a release process, the brake controller 25 first switches from a voltage-free state “off” to a state in which the initial high voltage is applied to the coil 18 of the electromagnet 17. The brake controller 25 monitors the current flowing through the coil 18 with the aid of the current measuring device 27. As soon as the current intensity I(t) has characteristics which typically indicate a movement of the armature 15 from the braking position into the release position, the brake controller 25 switches to the lower holding voltage.

At the same time, the brake controller 25 can generate a brake release confirmation signal and output it, for example, at a signal output 45 in order to inform other components, if necessary, that the brake 3 has been released. As a result, brake actuation monitoring contacts 39—as they were conventionally used in brake systems in order to be able to monitor the actuation of the brake 3, and as they are only drawn in in FIG. 3 for better understanding—can be superfluous.

If the brake controller 25 cannot detect any movement of the armature 15 toward the release position during a release process, for example due to a defect or a malfunction, it can be provided that the brake controller 25 automatically reduces the applied voltage to the holding voltage after a predetermined waiting time has elapsed. This can prevent the coil 18 from heating up excessively due to excessively high currents. If necessary, the brake controller 25 can then output an error signal.

As soon as the brake 3 is to be activated again, the brake controller 25 receives a corresponding activation signal from an elevator controller 37. The brake controller 25 then switches to an “off” state in which no more voltage is applied from the voltage source 23 to the coil 18. The coil 18 then dissipates the energy stored in it via the parallel-connected diode 43 and the separate shunt resistor 41, which may also be provided. As a result, the magnetic field generated by the coil 18 also collapses, so that the armatures 15 are moved toward their braking position due to the spring force caused by the spring element 9 and the brake 3 is thus actuated.

Finally, it should be noted that terms such as “comprising,” “having,” etc. do not preclude other elements or steps and terms such as “a” or “an” do not preclude a plurality. Furthermore, it should be noted that features or steps that have been described with reference to one of the above embodiments may also be used in combination with other features or steps of other embodiments described above.

In accordance with the provisions of the patent statutes, the present invention has been described in what is considered to represent its preferred embodiment. However, it should be noted that the invention can be practiced otherwise than as specifically illustrated and described without departing from its spirit or scope.

1-9. (canceled)

10. A method for controlling a brake of an elevator system, wherein the brake has an armature that is pulled by an electromagnet to release the brake from a braking position against a spring force into a release position, the method comprising the steps of:
applying an initial electrical voltage to the electromagnet and measuring a current intensity supplied to the electromagnet in response to the initial electrical voltage; and
reducing the initial electrical voltage applied to the electromagnet to a holding voltage in response to a detection of a typical time behavior of the measured current intensity that characteristically occurs when the armature moves from the braking position into the release position.

11. The method according to claim 10 wherein a reduction in the measured current intensity when the initial voltage is applied is detected as the typical time behavior.

12. The method according to claim 10 wherein an increase in the measured current intensity after a decrease in the measured current intensity is detected as the typical time behavior.

13. The method according to claim 10 wherein a typical time course of a current intensity resulting from the initial voltage applied to the electromagnet is determined in advance by one of calculation, simulation, and modeling, and wherein the typical time behavior is detected as a match within a predetermined tolerance between the measured current intensity and the determined typical time course of the current intensity.

14. The method according to claim 10 wherein the holding voltage is greater than or equal to an electrical voltage applied to the electromagnet required to hold the armature in the release position.

15. The method according to claim 10 wherein the holding voltage is at least 10% lower than the initial electrical voltage.

16. The method according to claim 10 including outputting a brake release confirmation signal in response to the detection of the typical time behavior of the measured current intensity.

17. A brake controller for controlling a brake of an elevator system, wherein the brake has an armature that is pulled by an electromagnet to release the brake from a braking position against a spring force into a release position, and wherein the brake controller is adapted to control and regulate by performing the method according to claim 10.

18. An elevator system comprising:
a brake having an armature that is pulled by an electromagnet to release the brake from a braking position against a spring force into a release position; and
the brake controller according to claim 17.
